(19) United States
(12) Patent Application Publication
(10) Pub. No.: US 2024/0402123 A1
(43) Pub. Date: Dec. 5, 2024

(54) Display Method, Computer Readable Medium, and Electrophoresis System

(71) Applicant: SHIMADZU CORPORATION, Kyoto-shi (JP)

(72) Inventors: Akira HARADA, Kyoto-shi (JP); Kota OGINO, Kyoto-shi (JP); Kazunori SHIMIZU, Kyoto-shi (JP); Takashi MORIMOTO, Kyoto-shi (JP)

(21) Appl. No.: 18/676,145

(22) Filed: May 28, 2024

(30) Foreign Application Priority Data
May 31, 2023 (JP) 2023-089464

(51) Int. Cl. G01N 27/447

(52) U.S. Cl. CPC G01N 27/44726

(57) ABSTRACT

An electrophoresis system includes: an electrophoresis apparatus; a control device that controls the electrophoresis apparatus; and a display device. The control device includes a calculation unit and an interface, the calculation unit calculates a required amount of the reagent for an electrophoresis process based on electrophoresis process information acquired via the interface, the calculation unit calculates a preparation amount of the reagent based on the required amount of the reagent, the preparation amount of the reagent being more than the required amount of the reagent, the preparation amount of the reagent being a round number, and the calculation unit displays the preparation amount of the reagent on the display device.

### CROSS REFERENCE TO RELATED APPLICATIONS

This nonprovisional application is based on Japanese Patent Application No. 2023-089464 filed on May 31, 2023 with the Japan Patent Office, the entire contents of which are hereby incorporated by reference.

### BACKGROUND OF THE INVENTION

### Field of the Invention

The present disclosure relates to a display method, a computer readable medium, and an electrophoresis system, more particularly, to display of a reagent for use in an electrophoresis apparatus.

### Description of the Background Art

When causing an electrophoresis apparatus to perform an electrophoresis process, a user needs to prepare a required amount of a reagent for the electrophoresis process.

Regarding display of information related to an amount of a reagent in an electrophoresis apparatus, Japanese Patent Laying-Open No. 2007-171216 discloses a technology in which an electrophoresis apparatus measures an amount of a reagent accommodated in the electrophoresis apparatus and displays a warning to a user when the amount of the reagent accommodated in the electrophoresis apparatus is insufficient to perform the electrophoresis process.

### SUMMARY OF THE INVENTION

When causing the electrophoresis apparatus to perform the electrophoresis process, the user calculates a preparation amount of the reagent based on the required amount of the reagent for the electrophoresis process, and accommodates the calculated preparation amount of the reagent in the electrophoresis apparatus.

It may be difficult to prepare the preparation amount of the reagent calculated based on the required amount of the reagent, and the user may feel it bothersome to prepare the preparation amount of the reagent.

The present disclosure has been made in view of such a situation, and has an object to reduce a burden on a user in preparing a reagent when causing an electrophoresis apparatus to perform an electrophoresis process.

A first aspect of the present disclosure is directed to a display method of displaying an amount of a reagent to be prepared by a user in an electrophoresis apparatus, the display method including: acquiring information of an electrophoresis process to be performed by the electrophoresis apparatus; calculating a required amount of the reagent for the electrophoresis process based on the information; calculating a preparation amount of the reagent based on the required amount of the reagent, the preparation amount of the reagent being more than the required amount of the reagent, the preparation amount of the reagent being a round number; and displaying the preparation amount of the reagent.

A second aspect of the present disclosure is directed to an electrophoresis system including: an electrophoresis mechanism; a control device that controls the electrophoresis mechanism; and a display device. The control device includes a calculation unit, and an interface. The calculation unit calculates a required amount of a reagent for an electrophoresis process based on electrophoresis process information acquired via the interface, the calculation unit calculates a preparation amount of the reagent based on the required amount of the reagent, the preparation amount of the reagent being more than the required amount of the reagent, the preparation amount of the reagent being a round number, and the display device displays the preparation amount of the reagent.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall configuration of an electrophoresis system according to the present embodiment.

FIG. 2 is a diagram showing an overall hardware configuration of the electrophoresis system.

FIG. 3 is a diagram schematically showing a configuration of a dispensing probe unit.

FIG. 4 is a diagram showing an exemplary display screen for a preparation amount of a reagent.

FIG. 5 is a diagram showing an exemplary display screen for a preparation amount of each component when the reagent is constituted of two components.

FIG. 6 is a diagram showing an exemplary display screen for a required amount of the reagent when an amount of the reagent accommodated in the electrophoresis apparatus is equal to or more than the required amount of the reagent.

FIG. 7 is a diagram showing an exemplary display screen for a warning when the amount of the reagent accommodated in the electrophoresis apparatus is less than the required amount of the reagent.

FIG. 8 is a flowchart showing a display process of a control device.

### DESCRIPTION OF THE PREFERRED EMBODIMENTS

Hereinafter, embodiments of the present disclosure will be described in detail with reference to figures. It should be noted that the same or corresponding portions in the figures are denoted by the same reference characters and will not be described repeatedly.

### [Overall Configuration of Electrophoresis System]

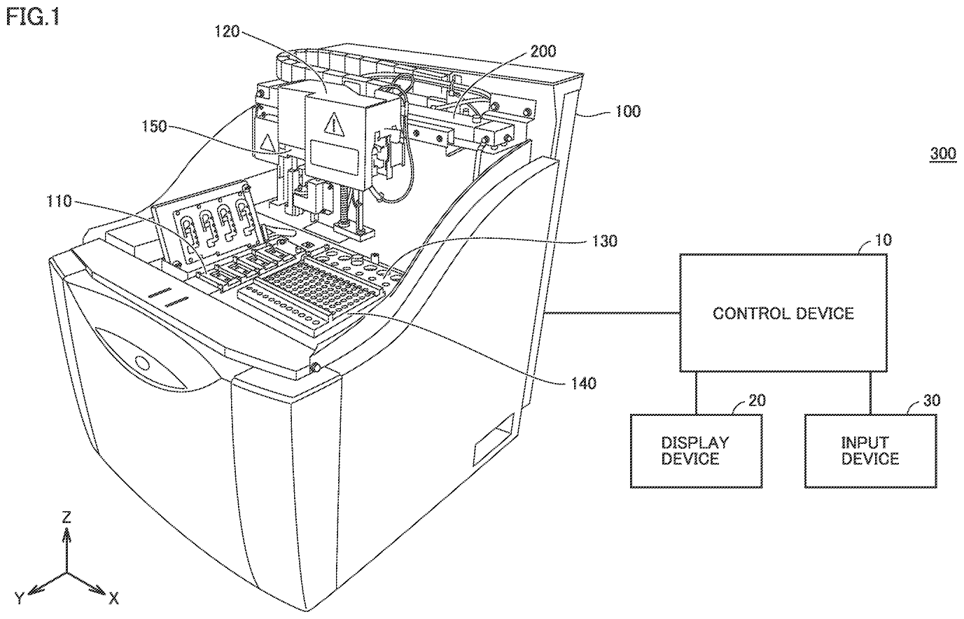

FIG. 1 is a diagram schematically showing an overall configuration of an electrophoresis system 300 according to the present embodiment. As shown in FIG. 1, electrophoresis system 300 includes a control device 10, a display device 20, an input device 30, and an electrophoresis apparatus 100. Control device 10 may be incorporated in electrophoresis apparatus 100. Further, control device 10, display device 20, and input device 30 may be incorporated in electrophoresis apparatus 100. As control device 10, for example, a personal computer or the like can be used.

Electrophoresis apparatus 100 includes a microchip holding portion 110, a dispensing probe unit 120, a reagent holding portion 130, a sample holding portion 140, a pressure-application/suction unit 150, and a driving device 200. Electrophoresis apparatus 100 is connected to control device 10 so as to communicate therewith. After a sample is placed on a specific supporting body, electrophoresis apparatus 100 applies a voltage to the sample so as to separate a component in the sample in accordance with a chain length thereof. The supporting body is, for example, a gel or membrane.

In FIG. 1, each of dispensing probe unit 120 and pressure-application/suction unit 150 is disposed on one side (upper side in FIG. 1) with respect to each of microchip holding portion 110, reagent holding portion 130, and sample holding portion 140 in the Z axis direction.

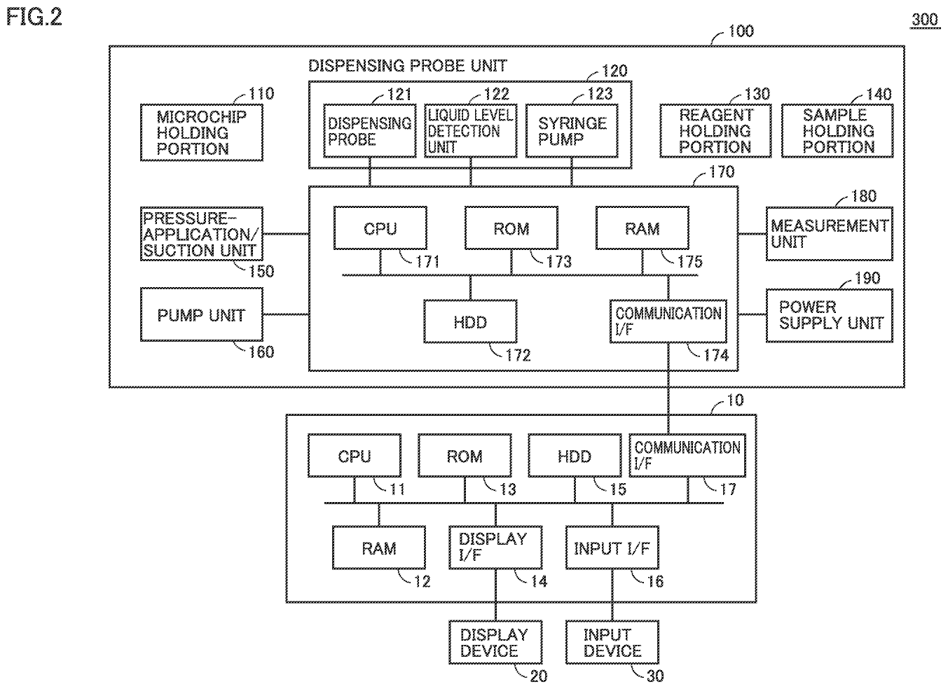

FIG. 2 is a diagram showing a hardware configuration of each component of electrophoresis system 300. Next, configurations of electrophoresis apparatus 100, control device 10, display device 20, and input device 30 will be described further with reference to FIG. 2.

### [Configuration of Electrophoresis Apparatus]

Electrophoresis apparatus 100 further includes a pump unit 160, a controller 170, a measurement unit 180, and a power supply unit 190.

Microchip holding portion 110 holds a microchip. Microchip holding portion 110 is implemented by a recess formed in a horizontal plane (X-Y plane in FIG. 1) inside electrophoresis apparatus 100. An electrophoresis channel for separating a sample is formed in the microchip. The microchip may be configured to be repeatedly usable by cleaning the microchip. It should be noted that the microchip may be a disposable type microchip to be discarded when used once.

Dispensing probe unit 120 includes a dispensing probe 121, a liquid level detection unit 122, and a syringe pump 123. Dispensing probe unit 120 is connected to driving device 200. Dispensing probe unit 120 dispenses each of the reagent and the sample to the microchip. The configuration of dispensing probe unit 120 will be described later.

Dispensing probe unit 120 can be moved in the horizontal direction (direction along the X-Y plane in FIG. 1) and the vertical direction (Z axis direction in FIG. 1) by driving device 200, and discharges each of the reagent and the sample to the microchip held by microchip holding portion 110, suctions the reagent held by reagent holding portion 130, and suctions the sample held by sample holding portion 140.

Reagent holding portion 130 holds a reagent. Examples of the reagent include a separation buffer, a marker solution, a pre-preparation separation buffer, a fluorescent dye solution, a cleaning liquid, a cleaning solution, and water. Reagent holding portion 130 holds the reagent by retaining, in a hole formed in reagent holding portion 130, a container in which the reagent is accommodated, for example.

Sample holding portion 140 holds a sample. Examples of the sample includes a protein, a saccharide, or a nucleic acid (for example, RNA (ribonucleic acid) or DNA (deoxyribonucleic acid)). Sample holding portion 140 holds the sample by retaining, in a hole formed in sample holding portion 140, a container in which the sample is accommodated, for example.

Pressure-application/suction unit 150 applies a pressure to introduce a separation buffer into the electrophoresis channel of the microchip held by microchip holding portion 110. Pressure-application/suction unit 150 is connected to driving device 200. Pressure-application/suction unit 150 can be moved in the horizontal direction (direction along the X-Y plane in FIG. 1) and the vertical direction (Z axis direction in FIG. 1) by driving device 200. Pressure-application/suction unit 150 applies an air pressure to introduce the separation buffer into the electrophoresis channel formed in the microchip held by microchip holding portion 110.

Pump unit 160 discharges an unnecessary liquid to the outside from the microchip held by microchip holding portion 110. A suction port of the pump unit is connected to the tip of the electrophoresis channel of the microchip.

Controller 170 generally controls operations of dispensing probe unit 120, pressure-application/suction unit 150, pump unit 160, measurement unit 180, and power supply unit 190. Controller 170 includes, as main components, a CPU (Central Processing Unit) 171, a ROM (Read Only Memory) 173, a RAM (Random Access Memory) 175, an HDD (Hard Disk Drive) 172, and a communication I/F (Interface) 174. The components are connected to one another by a data bus.

ROM 173 can store a program to be executed by CPU 171. RAM 175 can temporarily store data generated by execution of a program in CPU 171 and data input via communication I/F 174, and can function as a primary storage device. HDD 172 is a nonvolatile storage device and can store information generated by electrophoresis apparatus 100. Controller 170 may have a semiconductor memory device such as a flash memory instead of HDD 172 or in addition to HDD 172.

Communication I/F 174 is an interface for communicating with an external device including control device 10. Communication I/F 174 is implemented by, for example, a network adapter. A communication method may be wireless communication such as Bluetooth (registered trademark) or wireless LAN (Local Area Network), or may be wired communication using USB (Universal Serial Bus) or the like.

Measurement unit 180 has an LED (Liquid Emitting Diode), an optical fiber, a filter, and a photomultiplier tube. Measurement unit 180 is configured to detect the sample separated through electrophoresis in the electrophoresis channel formed in the microchip held by microchip holding portion 110.

A method of detecting the sample by measurement unit 180 is, for example, as follows. The LED emits excitation light to a portion of the electrophoresis channel of the microchip. The sample, which is being moved in the electrophoresis channel, is excited by the excitation light from the LED to generate fluorescence, which is then received by the optical fiber. The filter blocks an excitation light component from the fluorescence received from the optical fiber, and allows only a fluorescence component to pass therethrough. The photomultiplier tube receives the fluorescent component having passed through the filter. The photomultiplier tube outputs, to control device 10, an analysis signal corresponding to an amount of the received light. Control device 10 detects the sample based on an intensity of the analysis signal.

Power supply unit 190 applies a voltage for electrophoresis to the electrophoresis channel of the microchip held by microchip holding portion 110. When the voltage is applied to the microchip having the sample and separation buffer introduced therein, each substance included in the sample is moved in one direction in the supporting body having a mesh-like three-dimensional structure. On this occasion, the substances included in the sample are separated in accordance with a degree of ease of passage of each substance included in the sample through the supporting body. In response to the excitation light emitted from the LED in measurement unit 180, each of the separated substances emits fluorescence due to a fluorescent dye included in the supporting body. Thus, electrophoresis apparatus 100 can analyze a target substance for analysis.

### [Configuration of Dispensing Probe Unit]

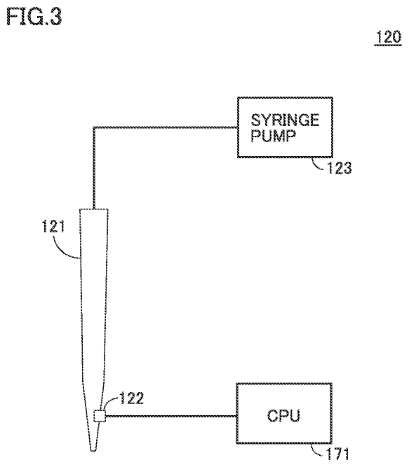

FIG. 3 is a diagram schematically showing a configuration of a dispensing probe unit. The configuration of dispensing probe unit 120 will be described further with reference to FIG. 3.

Syringe pump 123 can adjust air pressure in dispensing probe 121 by reciprocating a plunger so as to suction each of the reagent and the sample into dispensing probe 121 or so as to discharge each of the reagent and the sample from dispensing probe 121 to the outside.

Liquid level detection unit 122 is, for example, a capacitive type liquid level sensor attached to a tip of dispensing probe 121, and can detect a liquid level based on a change in capacitance between the liquid level and liquid level detection unit 122. Liquid level detection unit 122 is connected to CPU 171 so as to communicate therewith.

### [Configuration of Control Device]

Referring to FIG. 2 again, control device 10 has, as main components, a CPU 11, a ROM 13, a RAM 12, an HDD 15, a display I/F 14, an input I/F 16, and a communication I/F 17. The components are connected to one another by a data bus.

Control device 10 is connected to electrophoresis apparatus 100 so as to communicate therewith and exchanges data with electrophoresis apparatus 100. Control device 10 is an external control device that receives an instruction to electrophoresis apparatus 100 from the user, that controls the operation of electrophoresis apparatus 100, and that receives and processes data acquired by electrophoresis apparatus 100. The data is, for example, the amount of the reagent accommodated in reagent holding portion 130 and measured by liquid level detection unit 122.

Communication I/F 17 is an interface for communicating with an external device including electrophoresis apparatus 100. Communication I/F 17 is implemented by, for example, a network adapter. A communication method may be wireless communication such as Bluetooth (registered trademark) or wireless LAN, or may be wired communication using USB or the like.

Input I/F 16 relays data transmission between CPU 11 and input device 30. Input I/F 16 receives various types of information (for example, instructions to control device 10 and electrophoresis apparatus 100 as well as electrophoresis process information) provided by a manipulation on input device 30. The electrophoresis process information is information that defines a condition of the electrophoresis process, and more specifically, the electrophoresis process information includes at least one of a type of a kit, a mixing mode, the number of times of performing the electrophoresis process, and a cleaning method.

The kit means a set of reagents to be used in one type of electrophoresis process. Examples of the type of the kit include a DNA-500 kit, a DNA-1000 kit, a DNA-2500 kit, a DNA-12000 kit, and an RNA kit. Different colors are respectively assigned to the kits in accordance with the types of the kits in order to readily distinguish the type of each kit by the user. Each of the kits is packed in a package including the color assigned to the kit. Amounts and ratios of the reagents included therein differ among the kits, and the user selects a kit suitable for a target sample for analysis. Examples of the mixing mode include: an “on-chip mixing mode” in which the sample and a marker solution are mixed in the electrophoresis apparatus; and a “premix mode” in which the marker solution for the sample is mixed in advance.

Display I/F 14 relays data transmission between CPU 11 and display device 20. In accordance with a command from CPU 11, display I/F 14 outputs, to display device 20, a signal for displaying various types of information (for example, a preparation amount of a reagent, a required amount of the reagent, an amount of the reagent accommodated in electrophoresis apparatus 100, and a warning).

ROM 13 can store a program to be executed by CPU 11. RAM 12 can temporarily store data generated by execution of a program in CPU 11, data input via communication I/F 17, and the electrophoresis process information input by the user via input device 30, and can function as a primary storage device. HDD 15 is a nonvolatile storage device, and can store data acquired by electrophoresis apparatus 100, the electrophoresis process information input by the user, a kit database, and a required-amount database. Control device 10 may have a semiconductor memory device such as a flash memory instead of HDD 15 or in addition to HDD 15.

In the kit database, the types of the reagents included in the kits are registered. In the required-amount database, required amounts of the respective types of reagents for performing the electrophoresis process and the cleaning process once are registered.

The electrophoresis process includes: dispensing, by dispensing probe unit 120, each of the separation buffer and the sample into the microchip held by microchip holding portion 110; applying a voltage by power supply unit 190 to the microchip; and discharging, by pump unit 160, a solution remaining in the microchip.

The cleaning process is a process of cleaning the microchip held by microchip holding portion 110 with a cleaning liquid.

### [Configuration of Display Device]

Display device 20 is constituted of, for example, a display. In accordance with a command from CPU 11, display device 20 displays various types of information acquired via display I/F 14, such as the preparation amount of the reagent, the required amount of the reagent, the amount of the reagent accommodated in electrophoresis apparatus 100, and the warning.

### [Configuration of Input Device]

Input device 30 is constituted of, for example, a keyboard, a mouse, and the like. Input device 30 receives instructions to control device 10 and electrophoresis apparatus 100 and the electrophoresis process information from the user, and outputs them to CPU 11 via input I/F 16. Alternatively, a touch panel in which input device 30 and display device 20 are integrated may be used.

### [Specific Example of Display of Preparation Amount of Reagent]

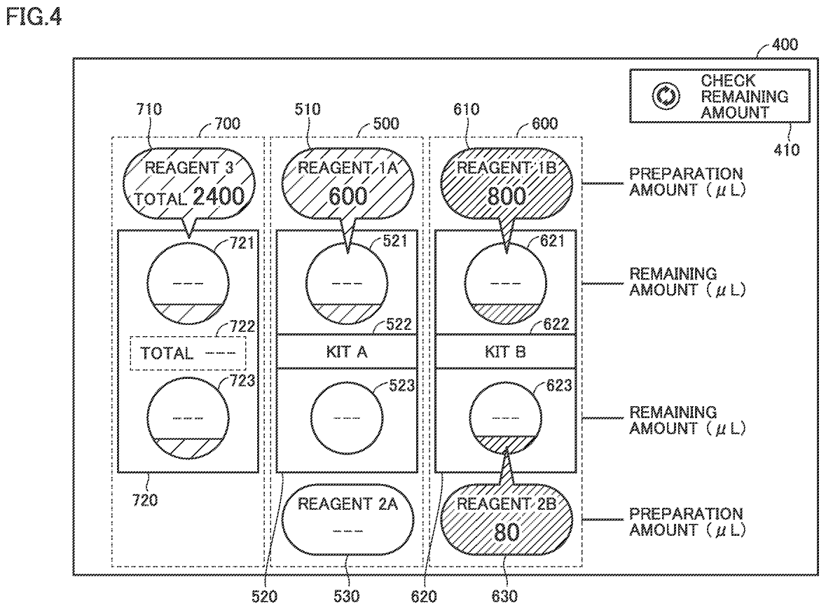

The following describes an exemplary display screen for a preparation amount of a reagent, the display screen being output when CPU 11 receives the electrophoresis process information. FIG. 4 is a diagram showing the exemplary display screen.

It should be noted that the following describes a case where two types of kits, i.e., “kit A” and “kit B” are used. Kit A includes a reagent 1A and a reagent 2A, and kit B includes a reagent 1B and a reagent 2B. Further, a “reagent 3” is used as a reagent other than the reagents included in the kits.

When the electrophoresis process information is received, CPU 11 displays a display screen 400 as shown in FIG. 4 on display device 20 via display I/F 14. Display screen 400 includes a check button 410, a window 500, a window 600, and a window 700.

Window 500 includes a box 510, a box 520, and a box 530. Box 510 displays a preparation amount of reagent 1A included in kit A. Box 530 displays a preparation amount of reagent 2A included in kit A.

Box 520 has: a section 521 for displaying an amount of reagent 1A accommodated in electrophoresis apparatus 100; a section 523 for displaying an amount of reagent 2A accommodated in electrophoresis apparatus 100; and a section 522 for displaying the name of the corresponding kit.

Window 600 includes a box 610, a box 620, and a box 630. Box 610 displays a preparation amount of reagent 1B included in kit B. Box 630 displays a preparation amount of reagent 2B included in kit B.

Box 620 has: a section 621 for displaying an amount of reagent 1B accommodated in electrophoresis apparatus 100; a section 623 for displaying an amount of reagent 2B accommodated in electrophoresis apparatus 100; and a section 622 for displaying the name of the corresponding kit.

Window 700 includes a box 710 and a box 720. Box 710 displays a preparation amount of reagent 3.

Box 720 includes three sections 721, 722, 723. Here, reagent 3 is, for example, a reagent (for example, a cleaning liquid or water) for use in the cleaning process for cleaning the electrophoresis channel. In that case, a larger amount of reagent 3 is required than those of the other reagents. Therefore, reagent holding portion 130 is provided with two holes (hereinafter, referred to as a “first hole” and a “second hole”) to accommodate reagent 3.

Section 721 displays an amount of reagent 3 accommodated in the first hole. Section 723 displays an amount of reagent 3 accommodated in the second hole. Section 722 displays the total of the numerical value displayed in section 721 and the numerical value displayed in section 723.

The electrophoresis process information includes a type of a kit designated by the user. When the user designates kit A in the electrophoresis process information, CPU 11 displays the name of kit A in section 522. When the user designates kit A and kit B in the electrophoresis process information, CPU 11 displays the name of kit A in section 522 and displays the name of kit B in section 622.

When the user designates a type of a kit in the electrophoresis process information, CPU 11 makes reference to the kit database so as to determine a type of a reagent included in the designated type of kit. That is, in the present embodiment, a type of a reagent is specified by specifying a type of a kit. Thus, the electrophoresis process information includes a type of a kit and therefore indirectly includes a type of a reagent. CPU 11 displays the names of the determined types of reagents in boxes 510, 530, 610, 630.

More specifically, when the user designates kit A in the electrophoresis process information, CPU 11 displays, in boxes 510, 530, the names of the reagents included in kit A. When the user designates kit A and kit B in the electrophoresis process information, CPU 11 displays, in boxes 510, 530, the names of the reagents included in kit A, and displays, in boxes 610, 630, the names of the reagents included in kit B.

It should be noted that CPU 11 can display pieces of information on the display screen in different manners for respective types of kits. For example, CPU 11 can display the name of the kit in section 522 in a manner different from that in section 622. CPU 11 can display the names of the reagents in boxes 510, 530 in a manner different from those in boxes 610, 630. An exemplary different manner is to display in a different color.

It should be noted that when the mixing mode designated by the user is the “premix mode”, mixing of the reagents in the apparatus is not required, with the result that part of the reagents may not be required. In this case, a preparation amount of a reagent not required is not displayed. Box 530 in FIG. 4 shows an exemplary display screen when reagent 2A is not required. In the example of FIG. 4, no numerical value is displayed in box 530 that would have otherwise indicated the preparation amount of reagent 2A.

### [Calculation of Preparation Amount of Reagent]

CPU 11 calculates a required amount of a reagent based on the acquired electrophoresis process information, and calculates a preparation amount of the reagent based on the calculated required amount of the reagent. The required amount of the reagent is a required amount of the reagent for completing the electrophoresis process. The preparation amount of the reagent is an amount of the reagent to be actually prepared by the user. The preparation amount of the reagent must be larger than the required amount of the reagent.

CPU 11 makes reference to the required-amount database, and acquires a required amount of each determined reagent for performing the electrophoresis process once. CPU 11 calculates the required amount of each reagent based on the product of the number of times of performing the electrophoresis process as input by the user and the required amount of the reagent for performing the electrophoresis process once. CPU 11 calculates the preparation amount of the reagent by converting the calculated required amount of the reagent into a round-number value that is larger than the required amount. CPU 11 displays the calculated preparation amounts of the reagents in boxes 510, 530, 610, 630, 710 in accordance with the types of the reagents.

The conversion into a round-number value is, for example, to set, as the preparation amount of the reagent, a minimum value that is an integral multiple of a specific value set in advance and that is more than the required amount of the reagent. The specific value is a value such as 5 μL, 10 μL, 100 μL, 200 μL, 500 μL, or 1000 μL, for example. More specifically, when the specific value is “200 μL”, the preparation amount of the reagent is set as any one of values that are each an integer multiple of 200 μL, such as 200 μL, 400 μL, 600 μL, 800 μL, 1000 μL, . . .

For example, when the required amount of the reagent is “720 μL”, the minimum amount more than the required amount of the reagent among the numerical values that are each an integer multiple of 200 μL is “800 μL”. Therefore, on this occasion, converting the required amount of the reagent, i.e., “720 μL”, into a round-number amount is to set the preparation amount of the reagent to “800 μL”.

Further, when the required amount of the reagent is “600 μL”, the minimum amount more than the required amount of the reagent among the numerical values that are each an integer multiple of 200 μL is “800 μL”. Therefore, on this occasion, converting the required amount of the reagent, i.e., “600 μL”, into a round-number amount is to set the preparation amount of the reagent to “800 μL”.

It should be noted that the conversion into a round-number value may be performed by setting, as the preparation amount of the reagent, a minimum value that is an integral multiple of a specific value set in advance and that is equal to or more than the required amount of the reagent. In this case, in the above example, when the required amount of the reagent is “600 μL”, the minimum amount equal to or more than the required amount of the reagent among the numerical values that are each an integer multiple of 200 μL is “600 μL”. Therefore, on this occasion, converting the required amount of the reagent, i.e., “600 μL” into a round-number amount is to set the preparation amount of the reagent to “600 μL”.

When a first reagent and a second reagent different from the first reagent are present as the reagents included in the kit, it is considered to configure such that a specific value for the second reagent is set to a value smaller than a specific value for the first reagent. For example, assume that a required amount of the second reagent for performing an analysis once is extremely smaller than a required amount of the first reagent for performing the analysis once. In such a case, since the specific values are made different from each other so as to reduce a difference between the preparation amount of the second reagent and the required amount of the second reagent, an unused amount of the reagent in the electrophoresis process can be reduced. Specifically, the specific value for the second reagent is set to “10 μL”, and the specific value for the first reagent is set to “100 μL”. This process is effective when an amount of the second reagent to be used should be reduced because the second reagent is more expensive than the first reagent, for example.

When the reagent is a reagent for use in the cleaning process for cleaning the electrophoresis channel, CPU 11 acquires, from the required-amount database stored in HDD 15, a required amount of the reagent for performing the cleaning process once. The required amount of the reagent is calculated based on the electrophoresis process information input by the user. For example, when the user has instructed to perform the cleaning whenever the electrophoresis process is ended once, CPU 11 calculates the required amount of the reagent from the product of the number of performing the electrophoresis process as input by the user and the required amount of the reagent for performing the cleaning process once. On the other hand, for example, when the cleaning is instructed after the end of all of the number of times of performing the electrophoresis process as input by the user, the required amount of the reagent for performing the cleaning process once is set as the required amount of the reagent.

Then, CPU 11 calculates the preparation amount of the reagent by converting the required amount of the reagent calculated as described above into a round-number value that is more than the required amount of the reagent.

### [Modification of Display of Preparation Amount of Reagent]

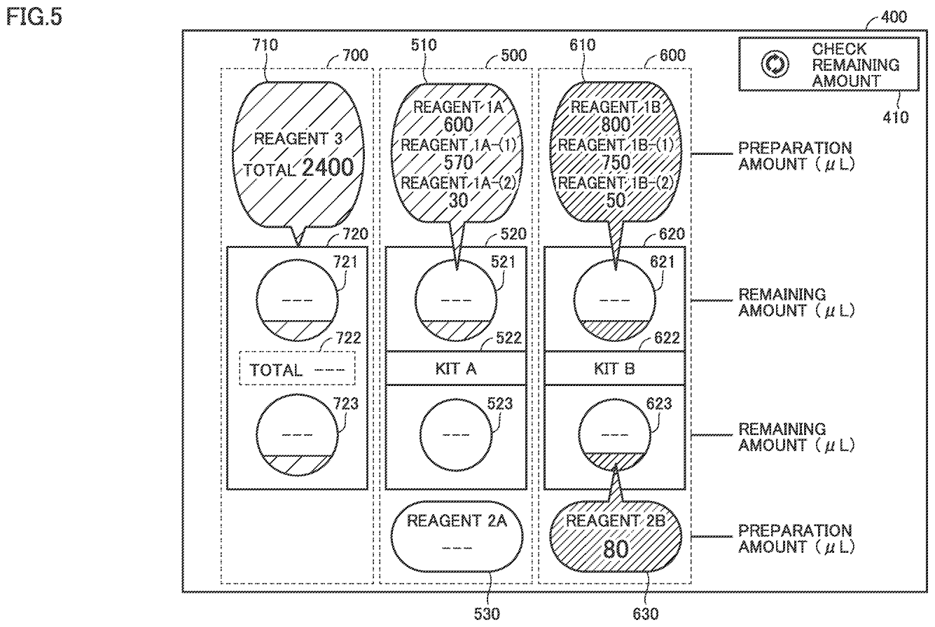

FIG. 5 is a diagram showing a modification of the display screen of FIG. 4. Referring to FIG. 5, the following describes display of a preparation amount of a reagent when the reagent is a mixture of a plurality of components. It should be noted that FIG. 5 is different from FIG. 4 only in terms of contents displayed in boxes 510, 610.

When the reagent is a mixture in which a plurality of components are mixed at a specific ratio, CPU 11 displays a mixed amount of each component together with a preparation amount of the reagent in box 510 as shown in FIG. 5.

For example, assume that reagent 1A is a mixture obtained by mixing a reagent 1A-(1) and a reagent 1A-(2) at 19:1. In this case, CPU 11 displays, in box 510, a preparation amount “600” of reagent 1A as well as a required amount (“570”) of reagent 1A-(1) and a required amount (“30”) of reagent 1A-(2) each for preparing the preparation amount (“600”) of reagent 1A.

Further, as shown in FIG. 5, CPU 11 also displays a preparation amount of reagent 1B and amounts of components of reagent 1B in box 610. For example, assume that reagent 1B is a mixture obtained by mixing a reagent 1B-(1) and a reagent 1B-(2) at 15:1. In this case, CPU 11 displays, in box 610, a preparation amount (“800”) of reagent 1B as well as a required amount (“750”) of reagent 1B-(1) and a required amount (“50”) of reagent 1B-(2) each for preparing the preparation amount (“800”) of reagent 1B.

By displaying not only the preparation amount of the reagent but also the amounts of the components of the reagent, the user can readily check the amount of each component required to be mixed when preparing the reagent.

### [Display of Required Amount of Reagent and Amount of Reagent Accommodated in Electrophoresis Apparatus]

Check button 410 is an item to be manipulated to display a required amount of a reagent and an amount of the reagent accommodated in electrophoresis apparatus 100. When check button 410 is manipulated by the user, CPU 11 displays the required amounts of the reagents in boxes 510, 530, 610, 630, 710, and outputs, to dispensing probe unit 120, an instruction to measure the amounts of the reagents accommodated in electrophoresis apparatus 100. In response to this instruction, dispensing probe unit 120 measures, using liquid level detection unit 122, each of the amounts of the reagents held in the plurality of holes in reagent holding portion 130. Measurement results by liquid level detection unit 122 respectively include amounts corresponding to sections 521, 523, 621, 623, 721, 723. Then, CPU 11 displays the measurement results in sections 521, 523, 621, 623, 721, 723, respectively.

[Display after Comparison between Amount of Reagent Accommodated in Electrophoresis Apparatus and Required Amount of Reagent]

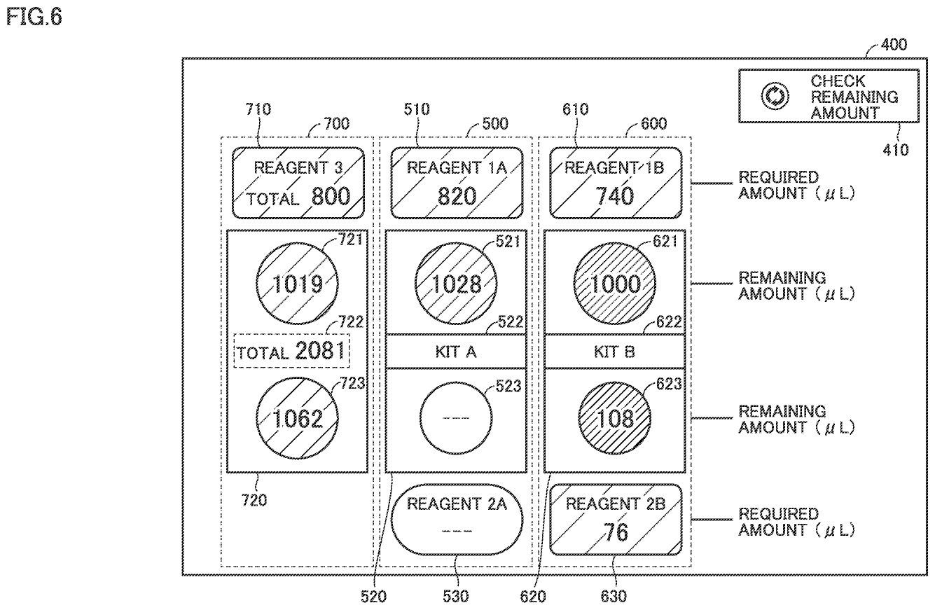

Next, the following describes a display screen output by CPU 11 after CPU 11 receives the measurement result of each of the amounts of the reagents accommodated in electrophoresis apparatus 100. FIG. 6 is a diagram showing another exemplary display screen.

When each of the measurement results of the amounts of the reagents accommodated in electrophoresis apparatus 100 is acquired, CPU 11 compares the amount of the reagent accommodated in electrophoresis apparatus 100 with the required amount of the reagent. When the amount of the reagent accommodated in electrophoresis apparatus 100 is equal to or more than the required amount of the reagent, the amount of the reagent accommodated in the electrophoresis apparatus and the required amount of the reagent are displayed on display screen 400 in a display manner different from the display manner shown in FIG. 4. An exemplary different manner is to display a different graphic and/or a different color. For example, each of boxes 510, 610, 630, 710 has an elliptical shape in FIG. 4, whereas each of boxes 510, 610, 630, 710 has a rounded rectangular shape in FIG. 6. Further, each of boxes 510, 610, 630, 710 is solidly painted in the same color (for example, light gray) so as to indicate that the amount of the reagent accommodated in electrophoresis apparatus 100 meets the required amount of the reagent. Sections 521, 621, 623, 721, 723 are also solidly painted in colors assigned to the kits.

It should be noted that when the mixing mode designated by the user is the “premix mode”, mixing of the reagents in the apparatus is not required, with the result that a reagent may not be required. In this case, a required amount of the reagent and an amount of the reagent accommodated in electrophoresis apparatus 100 are not displayed. Section 523 and box 530 in FIG. 6 represent exemplary display screens when reagent 2A is not required. In the example of FIG. 6, no numerical values are displayed in section 523 that would have otherwise indicated the amount of reagent 2A accommodated in electrophoresis apparatus 100 and box 530 that would have otherwise indicated the required amount of reagent 2A.

When kit A is designated in the electrophoresis process information by the user, the required amounts of the reagents included in kit A are displayed in boxes 510, 530. When kit A and kit B are designated by the user in the electrophoresis process information, CPU 11 displays, in boxes 510, 530, the required amounts of the reagents included in kit A, and displays, in boxes 610, 630, the required amounts of the reagents included in kit B.

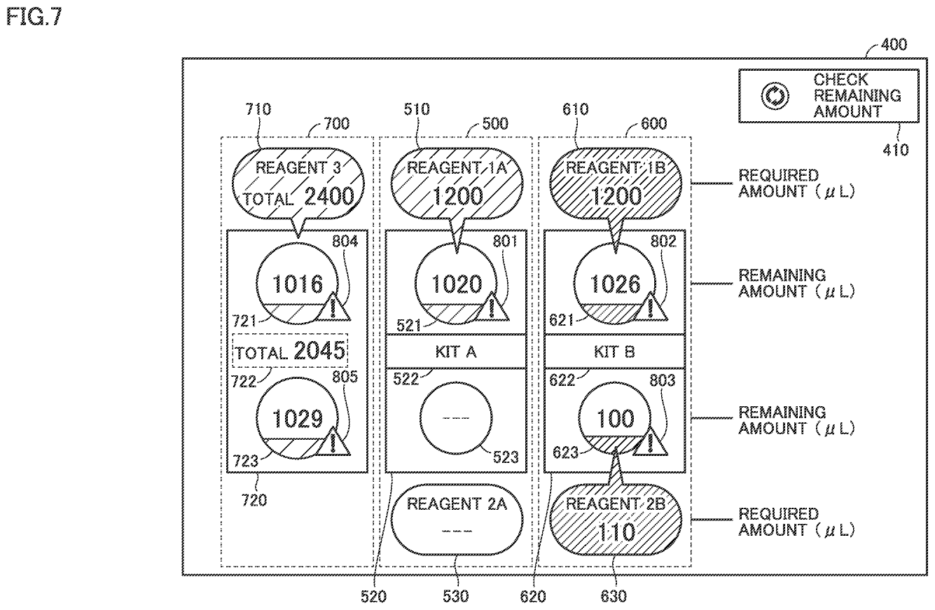

When the amount of each reagent accommodated in electrophoresis apparatus 100 is less than the required amount of the reagent as a result of comparing the amount of the reagent accommodated in electrophoresis apparatus 100 with the required amount of the reagent, CPU 11 displays a warning on display device 20 via display I/F 14. FIG. 7 is a diagram showing exemplary display of the warning. A warning display method will be described with reference to FIG. 7.

In FIG. 7, since the amount of reagent 1A accommodated in electrophoresis apparatus 100 is less than the required amount of reagent 1A, CPU 11 solidly paints the lower portion of section 521 in a color corresponding to the reagent kit, and displays a warning 801 in window 500. The user checks the display of the warning, recognizes that the amount of the reagent accommodated in electrophoresis apparatus 100 is less than the required amount of the reagent, and replenishes the reagent. As with reagent 1A, CPU 11 displays warnings 802, 803, 804, 805 when the amounts of corresponding reagents accommodated in electrophoresis apparatus 100 are less than the required amounts of the reagents as shown in FIG. 7.

### [Display for Checking Preparation Amount of Reagent]

When the measurements of the amounts of all the reagents accommodated in electrophoresis apparatus 100 are ended, CPU 11 displays the preparation amounts of the reagents in boxes 510, 530, 610, 630, 710.

### [Display Process by Control Device]

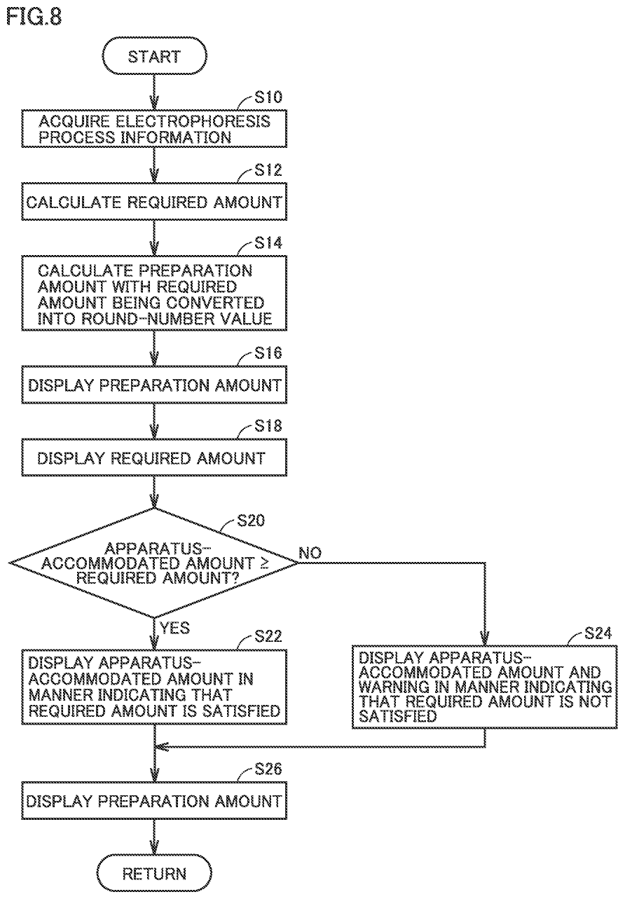

FIG. 8 is a flowchart showing a display process performed by CPU 11 in control device 10. It should be noted that in FIG. 8, the expression “APPARATUS-ACCOMMODATED AMOUNT” means the amount of the reagent accommodated in electrophoresis apparatus 100. A subroutine process of the display process of FIG. 8 is invoked from a main routine and is executed when the electrophoresis process information is input by the user.

Referring to FIG. 8, in S10, CPU 11 acquires the electrophoresis process information input from the user via input device 30 and input I/F 16.

In S12, based on information of the kit selected by the user in the acquired electrophoresis process information, CPU 11 makes reference to the kit database stored in HDD 15 so as to determine a type of each reagent included in the kit. Then, based on the determined type of the reagent, CPU 11 makes reference to the required-amount database stored in HDD 15 so as to acquire the required amount of the reagent for performing the electrophoresis process once. CPU 11 calculates the required amount of the reagent based on the product of the number of times of performing the electrophoresis process as included in the electrophoresis process information and the required amount of the reagent for performing the electrophoresis process once. When the required amount of the reagent is 0 in the mixing mode instructed by the user, CPU 11 does not calculate the required amount of the reagent.

In S14, CPU 11 converts the required amount of the reagent into a round-number value, thereby calculating the preparation amount of the reagent.

In S16, CPU 11 displays the calculated preparation amount of the reagent on display device 20.

In S18, CPU 11 displays the required amount of the reagent on display device 20.

In S20, CPU 11 receives an instruction from the user and transmits, to dispensing probe unit 120, the instruction to measure the amount of the reagent accommodated in electrophoresis apparatus 100. Dispensing probe unit 120 measures the amount of the reagent accommodated in electrophoresis apparatus 100 based on the instruction, and transmits the measured value to CPU 171. CPU 171 transmits, to CPU 11, the measured value of the amount of the reagent accommodated in electrophoresis apparatus 100. CPU 11 determines whether or not the amount of the reagent accommodated in electrophoresis apparatus 100 is equal to or more than the required amount of the reagent based on the measured value received from electrophoresis apparatus 100. When the amount of the reagent accommodated in electrophoresis apparatus 100 is equal to or more than the required amount of the reagent (Yes in S20), CPU 11 proceeds the process to S22, whereas when the amount of the reagent is less than the required amount of the reagent (No in S20), CPU 11 proceeds the process to S24.

In S22, CPU 11 displays the amount of the reagent accommodated in electrophoresis apparatus 100 on display device 20 in a manner indicating that the required amount of the reagent is satisfied.

In S24, CPU 11 displays the amount of the reagent accommodated in electrophoresis apparatus 100 and the warning on display device 20 in a manner indicating that the required amount of the reagent is not satisfied.

In S26, CPU 11 displays the preparation amount of the reagent on display device 20. Thereafter, CPU 11 ends the subroutine of the display process and returns the process to the main routine.

In the above-described display method according to the present embodiment, the user only needs to check the preparation amount of the reagent displayed on the display device in order to know the preparation amount of the reagent. Therefore, a burden on the user in preparing a reagent can be reduced.

Further, in the display method according to the present embodiment, when there are a plurality of types of reagents to be prepared by the user, the preparation amounts of the respective reagents are displayed in different display manners, thereby preventing the user from incorrectly recognizing the preparation amounts of the reagents.

Further, in the display method according to the present embodiment, when the electrophoresis apparatus is provided with a plurality of holes to accommodate the same reagent, the preparation amounts of the reagent to be accommodated in the respective holes are displayed in different display manners, thereby preventing the user from incorrectly recognizing the preparation amounts of the reagent.

Moreover, in the course of the calculation of the preparation amount in the present embodiment, the specific value for calculating a round-number value can be set. When the specific value is set, the preparation amount of the reagent is defined as an amount that is an integer multiple of the specific value and that is more than the required amount of the reagent. By displaying the preparation amount of the reagent, the user can readily recognize the preparation amount of the reagent.

Furthermore, in the course of the calculation of the preparation amount of the reagent in the present embodiment, when there are a plurality of types of reagents to be used, different values can be used as the specific values to be used in calculating the preparation amounts of the respective reagents. By setting a large specific value, the preparation amount of the reagent becomes a large amount by which the reagent can be prepared readily by the user, thereby reducing a burden on the user in preparing the reagent. On the other hand, by setting a small specific value, a difference between the preparation amount of the reagent and the required amount of the reagent becomes small, thereby reducing an amount of the reagent to be discarded without being used in the electrophoresis process.

### [Aspects]

It will be understood by one having ordinary skill in the art that the plurality of illustrative embodiments described above are specific examples of the following aspects.

(Item 1) A display method of displaying an amount of a reagent to be prepared by a user in an electrophoresis apparatus according to one aspect may include: acquiring information of an electrophoresis process to be performed by the electrophoresis apparatus; calculating a required amount of the reagent for the electrophoresis process based on the information; calculating a preparation amount of the reagent based on the required amount of the reagent, the preparation amount of the reagent being more than the required amount of the reagent, the preparation amount of the reagent being a round number; and displaying the preparation amount of the reagent.

With the display method according to item 1, there is provided a technology for allowing the user to readily recognize the preparation amount of the reagent.

(Item 2) The display method according to item 1 may further include: measuring an amount of the reagent accommodated in the electrophoresis apparatus; and displaying the measured amount of the reagent.

With the display method according to item 2, there is provided a technology for allowing the user to readily recognize the amount of the reagent accommodated in the electrophoresis apparatus.

(Item 3) The display method according to item 2 may further include notifying a warning when the measured amount of the reagent is less than the required amount of the reagent.

With the display method according to item 3, there is provided a technology for allowing the user to readily recognize that the amount of the reagent accommodated in the electrophoresis apparatus is less than the preparation amount of the reagent.

(Item 4) In the display method according to item 2, the reagent may include a first separation buffer and a second separation buffer different in type from the first separation buffer, and the displaying the amount of the reagent accommodated in the electrophoresis apparatus may include displaying an amount of the second separation buffer accommodated in the electrophoresis apparatus in a display manner different from a display manner for an amount of the first separation buffer accommodated in the electrophoresis apparatus.

With the display method according to item 4, there is provided a technology for allowing the user to readily recognize the amount of each separation buffer accommodated in the electrophoresis apparatus when two types of separation buffers are accommodated in the electrophoresis apparatus.

(Item 5) In the display method according to item 2, the reagent may include a first marker solution and a second marker solution different in type from the first marker solution, and the displaying the amount of the reagent accommodated in the electrophoresis apparatus may include displaying an amount of the second marker solution accommodated in the electrophoresis apparatus in a display manner different from a display manner for an amount of the first marker solution accommodated in the electrophoresis apparatus.

With the display method according to item 5, there is provided a technology for allowing the user to readily recognize the amount of each marker solution accommodated in the electrophoresis apparatus when two types of marker solutions are accommodated in the electrophoresis apparatus.

(Item 6) The display method according to item 2 may further include displaying the required amount of the reagent when the measured amount of the reagent is equal to or more than the required amount of the reagent.

With the display method according to item 6, there is provided a technology for allowing the user to readily recognize that the amount of the reagent accommodated in the electrophoresis apparatus is equal to or more than the required amount of the reagent.

(Item 7) In the display method according to item 6, the reagent accommodated in the electrophoresis apparatus may include a first separation buffer and a second separation buffer different in type from the first separation buffer, and the displaying the amount of the reagent accommodated in the electrophoresis apparatus may include displaying an amount of the second separation buffer accommodated in the electrophoresis apparatus in a display manner different from a display manner for an amount of the first separation buffer accommodated in the electrophoresis apparatus, and displaying a required amount of the second separation buffer in a display manner different from a display manner for a required amount of the first separation buffer.

With the display method according to item 7, there is provided a technology for allowing the user to readily recognize the amount of each of the first separation buffer and the second separation buffer accommodated in the electrophoresis apparatus and the required amount of each of the first separation buffer and the second separation buffer.

(Item 8) In the display method according to item 6, the reagent accommodated in the electrophoresis apparatus may include a first marker solution and a second marker solution different in type from the first marker solution, and the displaying the amount of the reagent accommodated in the electrophoresis apparatus may include displaying an amount of the second marker solution accommodated in the electrophoresis apparatus in a display manner different from a display manner for an amount of the first marker solution accommodated in the electrophoresis apparatus, and displaying a required amount of the second marker solution in a display manner different from a display manner for a required amount of the first marker solution.

With the display method according to item 8, there is provided a technology for allowing the user to readily recognize the amount of each of the first marker solution and the second marker solution accommodated in the electrophoresis apparatus and the required amount of each of the first marker solution and the second marker solution.

(Item 9) In the display method according to item 1, the reagent may include at least one of a separation buffer and a marker solution.

With the display method according to item 9, there is provided a technology for allowing the user to readily recognize the preparation amount of at least one of the separation buffer and the marker solution.

(Item 10) In the display method according to any one of items 1 to 9, the calculating the preparation amount of the reagent further includes setting a minimum value that is an integral multiple of a specific value and that is more than the required amount of the reagent.

With the display method according to item 10, there is provided a technology for allowing the user to readily recognize the round-number preparation amount of the reagent.

(Item 11) In the display method according to item 10, the reagent may include a separation buffer and a marker solution, the specific value may include a first specific value for the separation buffer and a second specific value for the marker solution, and the second specific value may be less than the first specific value.

With the display method according to item 11, the difference between the required amount of the marker solution and the preparation amount of the marker solution is equal to or less than the difference between the required amount of the separation buffer and the preparation amount of the separation buffer. Therefore, in the case of the separation buffer that is generally inexpensive, a large value by which the separation buffer is readily prepared by the user can be used as the preparation amount of the separation buffer. On the other hand, in the case of the marker solution that is generally expensive, the amount of the marker solution to be discarded without being used in the electrophoresis process can be reduced.

(Item 12) In the display method according to any one of items 1 to 11, the reagent may include a first separation buffer and a second separation buffer different in type from the first separation buffer, and the displaying the preparation amount of the reagent may include displaying a preparation amount of the second separation buffer in a display manner different from a display manner for a preparation amount of the first separation buffer.

With the display method according to item 12, there is provided a technology for preventing the user from incorrectly recognizing the preparation amount of each separation buffer when preparing two types of separation buffers.

(Item 13) In the display method according to any one of items 1 to 12, the reagent may include a first marker solution and a second marker solution different in type from the first marker solution, and the displaying the preparation amount may include displaying a preparation amount of the second marker solution in a display manner different from a display manner for a preparation amount of the first marker solution.

With the display method according to item 13, there is provided a technology for preventing the user from incorrectly recognizing the preparation amount of each marker solution when preparing two types of marker solutions.

(Item 14) In the display method according to any one of items 1 to 13, the reagent may include a separation buffer, the separation buffer may be obtained by mixing a pre-preparation separation buffer and a fluorescent dye solution at a specific ratio, and the display method may further include: calculating, based on the specific ratio, a mixed amount of the pre-preparation separation buffer and a mixed amount of the fluorescent dye solution in the preparation amount of the reagent; and displaying the mixed amount of the pre-preparation separation buffer and the mixed amount of the fluorescent dye solution.

With the display method according to item 14, there is provided a technology for reducing a burden on the user in preparing the separation buffer.

(Item 15) In the display method according to any one of items 1 to 14, the reagent may include a separation buffer and a marker solution, and the information may include at least one of a type of the separation buffer, a type of the marker solution, a mixing mode of the marker solution, and the number of times of performing the electrophoresis by the electrophoresis apparatus.

With the display method according to item 15, there is provided a technology for allowing the user to readily recognize the preparation amount of the reagent.

(Item 16) In the display method according to any one of items 1 to 15, the reagent may include a separation buffer, a marker solution, and a cleaning liquid, and the information may include at least one of a type of the separation buffer, a type of the marker solution, a mixing mode of the marker solution, the number of times of performing the electrophoresis by the electrophoresis apparatus, and a cleaning method to be performed using the cleaning liquid by the electrophoresis apparatus.

With the display method according to item 16, there is provided a technology for allowing the user to readily recognize the preparation amount of the reagent.

(Item 17) A computer readable medium according to one aspect is a non-transitory computer readable medium in which a program is recorded, wherein by executing the program by a processor of a controller, the program causes the controller to perform the display method according to any one of items 1 to 16.

With the computer readable medium according to item 17, there is provided a technology for allowing the user to readily recognize the preparation amount of the reagent and the amount of the reagent accommodated in the electrophoresis apparatus.

(Item 18) An electrophoresis system according to one aspect includes: an electrophoresis mechanism; a control device that controls the electrophoresis mechanism; and a display device, wherein the control device includes a calculation unit, and an interface, the calculation unit calculates a required amount of a reagent for an electrophoresis process based on electrophoresis process information acquired via the interface, the calculation unit calculates a preparation amount of the reagent based on the required amount of the reagent, the preparation amount of the reagent being more than the required amount of the reagent, the preparation amount of the reagent being a round number, and the display device displays the preparation amount of the reagent.

With the electrophoresis apparatus according to item 18, there is provided a technology for allowing the user to readily recognize the preparation amount of the reagent.

Although the embodiments of the present invention have been described and shown in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A display method of displaying an amount of a reagent to be prepared by a user in an electrophoresis apparatus, the display method comprising:
acquiring information of an electrophoresis process to be performed by the electrophoresis apparatus;
calculating a required amount of the reagent for the electrophoresis process based on the information;
calculating a preparation amount of the reagent based on the required amount of the reagent, the preparation amount of the reagent being more than the required amount of the reagent, the preparation amount of the reagent being a round number; and
displaying the preparation amount of the reagent.

2. The display method according to claim 1, further comprising:
measuring an amount of the reagent accommodated in the electrophoresis apparatus; and
displaying the measured amount of the reagent.

3. The display method according to claim 2, further comprising notifying a warning when the measured amount of the reagent is less than the required amount of the reagent.

4. The display method according to claim 2, wherein
the reagent includes a first separation buffer and a second separation buffer different in type from the first separation buffer, and
the displaying the amount of the reagent accommodated in the electrophoresis apparatus includes displaying an amount of the second separation buffer accommodated in the electrophoresis apparatus in a display manner different from a display manner for an amount of the first separation buffer accommodated in the electrophoresis apparatus.

5. The display method according to claim 2, wherein
the reagent includes a first marker solution and a second marker solution different in type from the first marker solution, and
the displaying the amount of the reagent accommodated in the electrophoresis apparatus includes displaying an amount of the second marker solution accommodated in the electrophoresis apparatus in a display manner different from a display manner for an amount of the first marker solution accommodated in the electrophoresis apparatus.

6. The display method according to claim 2, further comprising displaying the required amount of the reagent when the measured amount of the reagent is equal to or more than the required amount of the reagent.

7. The display method according to claim 6, wherein
the reagent accommodated in the electrophoresis apparatus includes a first separation buffer and a second separation buffer different in type from the first separation buffer, and
the displaying the amount of the reagent accommodated in the electrophoresis apparatus includes
displaying an amount of the second separation buffer accommodated in the electrophoresis apparatus in a display manner different from a display manner for an amount of the first separation buffer accommodated in the electrophoresis apparatus, and
displaying a required amount of the second separation buffer in a display manner different from a display manner for a required amount of the first separation buffer.

8. The display method according to claim 6, wherein
the reagent accommodated in the electrophoresis apparatus includes a first marker solution and a second marker solution different in type from the first marker solution, and
the displaying the amount of the reagent accommodated in the electrophoresis apparatus includes
displaying an amount of the second marker solution accommodated in the electrophoresis apparatus in a display manner different from a display manner for an amount of the first marker solution accommodated in the electrophoresis apparatus, and
displaying a required amount of the second marker solution in a display manner different from a display manner for a required amount of the first marker solution.

9. The display method according to claim 1, wherein the reagent includes at least one of a separation buffer and a marker solution.

10. The display method according to claim 1, wherein the calculating the preparation amount of the reagent includes setting a minimum value that is an integral multiple of a specific value and that is more than the required amount of the reagent.

11. The display method according to claim 10, wherein
the reagent includes a separation buffer and a marker solution,
the specific value includes a first specific value for the separation buffer and a second specific value for the marker solution, and
the second specific value is less than the first specific value.

12. The display method according to claim 1, wherein
the reagent includes a first separation buffer and a second separation buffer different in type from the first separation buffer, and
the displaying the preparation amount of the reagent includes displaying a preparation amount of the second separation buffer in a display manner different from a display manner for a preparation amount of the first separation buffer.

13. The display method according to claim 1, wherein
the reagent includes a first marker solution and a second marker solution different in type from the first marker solution, and
the displaying the preparation amount includes displaying a preparation amount of the second marker solution in a display manner different from a display manner for a preparation amount of the first marker solution.

14. The display method according to claim 1, wherein
the reagent includes a separation buffer,
the separation buffer is obtained by mixing a pre-preparation separation buffer and a fluorescent dye solution at a specific ratio,
the display method further comprising:
calculating, based on the specific ratio, a mixed amount of the pre-preparation separation buffer and a mixed amount of the fluorescent dye solution in the preparation amount of the reagent; and
displaying the mixed amount of the pre-preparation separation buffer and the mixed amount of the fluorescent dye solution.

15. The display method according to claim 1, wherein
the reagent includes a separation buffer and a marker solution, and
the information includes at least one of
a type of the separation buffer,
a type of the marker solution,
a mixing mode of the marker solution, and
the number of times of performing the electrophoresis by the electrophoresis apparatus.

16. The display method according to claim 1, wherein
the reagent includes a separation buffer, a marker solution, and a cleaning liquid, and
the information includes at least one of
a type of the separation buffer,
a type of the marker solution,
a mixing mode of the marker solution,
the number of times of performing the electrophoresis by the electrophoresis apparatus, and
a cleaning method to be performed using the cleaning liquid by the electrophoresis apparatus.

17. A non-transitory computer readable medium in which a program is recorded, wherein by executing the program by a processor of a controller, the program causes the controller to perform the display method according to claim 1.

18. An electrophoresis system comprising:
an electrophoresis mechanism;
a control device that controls the electrophoresis mechanism; and
a display device, wherein
the control device includes
a calculation unit, and
an interface,
the calculation unit calculates a required amount of a reagent for an electrophoresis process based on electrophoresis process information acquired via the interface,
the calculation unit calculates a preparation amount of the reagent based on the required amount of the reagent, the preparation amount of the reagent being more than the required amount of the reagent, the preparation amount of the reagent being a round number, and
the display device displays the preparation amount of the reagent.
